(19) United States
(12) Patent Application Publication
(10) Pub. No.: US 2013/0256060 A1
(43) Pub. Date: Oct. 3, 2013

(54) Scaffold Plank Structure

(71) Applicant: SAFWAY SERVICES, LLC, Waukesha, WI (US)

(72) Inventors: Robert Peter Wiegers, Fox Point, WI (US); Scott D. Libert, Waukesha, WI (US)

(73) Assignee: SAFWAY SERVICES, LLC, Waukesha, WI (US)

(21) Appl. No.: 13/802,309

(22) Filed: Mar. 13, 2013

Related U.S. Application Data
(60) Provisional application No. 61/617,648, filed on Mar. 29, 2012.

(51) Int. Cl. E04G 5/08; B23P 15/00; B21B 15/00

(52) U.S. Cl. CPC E04G 5/08; B21B 15/0007; B23P 15/00
USPC 182/222; 72/338; 72/203; 29/428

(57) ABSTRACT

A plank, such as a scaffold plank, is disclosed herein. In accordance with at least some embodiments, the scaffold plank comprising: a structure having a deck portion having surface upon which a worker can be supported, the portion including a plurality of perforations, the structure further having a pair of side portions extending from the surface, the side portions each including a flange with a bottom surface and a closed surface physically contacting the side portions; and a plurality of hook structures configured to receive and be supported by a scaffold system.

### FIELD OF THE INVENTION

The invention relates to a plank. In one aspect, the invention more particularly relates to a scaffold plank configured to prevent or at least substantially limit material or debris from accumulating on the plank, or at least a portion of the plank.

### BACKGROUND

Personnel access (e.g., scaffold) structures traditionally use wood or steel planks to create a worker platform surface for standing at a given height on a scaffold. This flat, solid surface has a tendency to act as a catch for debris or media (e.g., blast media). Accumulation of debris can potentially overload a scaffold, or potentially create a reservoir of dust and debris, facilitating a dirty work environment, which may prevent the proper application of corrosion resistant paints and coatings. For performing work (e.g., the removal of paint and debris from a ship, power plant boiler, etc.) it can be advantageous for the blast media and material removed not to accumulate on the worker platform, but to pass through the platform to be collected below.

It is known in the art to include openings on the surface of scaffolding planks in order to prevent the build-up of debris and facilitate the passage of debris through the plank. However, in order to retain stability and strength, these planks include sides which fold under the plank, forming open ledges. As debris passes through the plank, it accumulates on the ledges, potentially causing instability and otherwise negating the benefits of the openings.

It would be desirable to provide a new plank that overcomes the aforementioned and other drawbacks. Further, it would be desirable to provide a new plank that can be manufactured in a cost-effective manner.

### SUMMARY

In accordance with one aspect of the present disclosure, disclosed herein is a scaffold plank comprising a structure having a deck portion with a surface upon which a worker can be supported, the deck portion including a plurality of perforations, the structure further having a pair of opposing side portions extending from the surface, the side portions including a flange with a bottom surface and closed surface physically contacting the side portions; and a plurality of hook structures configured to receive and be supported by a scaffold system. Other embodiments, aspects, features, objectives and advantages of the present disclosure will be understood and appreciated upon a full reading of the detailed description and the claims that follow.

### BRIEF DESCRIPTION OF THE DRAWINGS

Embodiments are disclosed with reference to the accompanying drawings and are for illustrative purposes only. The present disclosure is not limited in its application to the details of construction or the arrangement of the components illustrated in the drawings. The present disclosure encompasses other embodiments and is capable of being practiced or carried out in other various ways. The drawings illustrate a best mode presently contemplated for carrying out the invention. Like reference numerals may be used to indicate like components.

In the drawings:

FIG. 1 is a perspective view of a portion of a scaffold plank in accordance with at least some embodiments of the present disclosure;

FIG. 2 is a cross-sectional view of a scaffold plank in accordance with at least some embodiments of the present disclosure;

FIG. 3 is a cross-sectional view of a scaffold plank in accordance with at least some embodiments of the present disclosure;

FIG. 4 is a cross-sectional view of a scaffold plank in accordance with at least some embodiments of the present disclosure; and

FIG. 5 illustrates top and cross-sectional views of exemplary embodiments of a scaffold plank in accordance with embodiments of the present disclosure.

Dimensions and/or materials are provided by way of example only.

### DETAILED DESCRIPTION

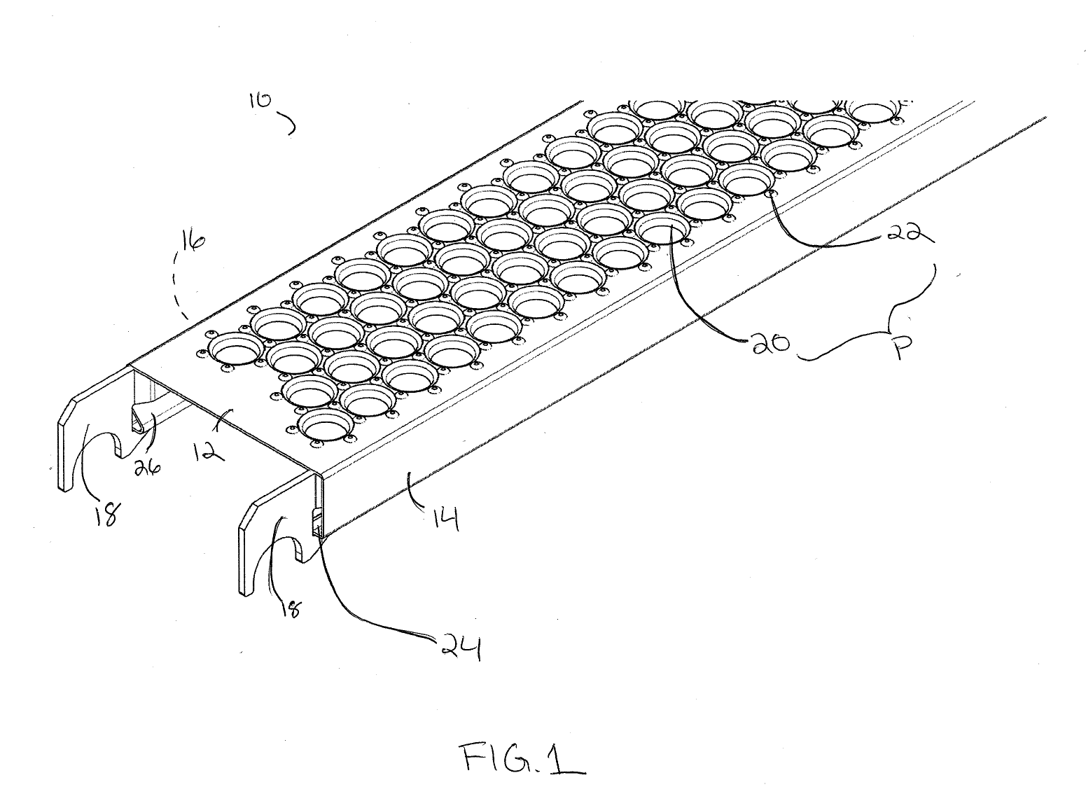

With reference to FIG. 1, and in accordance with embodiments of the present disclosure, a scaffold plank 10 is shown. The plank 10, as shown, comprises a one piece sheet metal deck 12, or deck portion, having a walking surface (or surface portion) and additional sides or side portions 14, 16 (with side 16 hidden and thus referenced with a dashed line). The sides 14, 16 are formed, and typically roll formed, to form structural flanges 24, 26, respectively, which protrude inward and underneath the metal deck 12. The same flanges 24, 26 are further formed, or roll closed, to prevent (or at least substantially prevent) accumulation of debris or other material (e.g., blast material) and support a load on deck 12.

It shall be understood that other manners of making or forming the respective portions, including the closed portions, are contemplated and considered within the scope of the present disclosure. The deck 12 is configured to be attached to a scaffold (not shown) by means of a plurality, as shown four (4), hooks 18 (2 of which are shown) that are welded or otherwise attached to the deck. The deck walking surface (or surface portion) has larger perforations 20 which, as shown, take the form of circular perforations and which permit or promote passage of debris or other material, as well as light, as well as smaller perforations 22 which take the form of, as shown, raised areas with holes, and which generally surround the larger perforations or openings. It is thought that the inclusion of smaller perforations 22 within the pattern of large perforations 20 may improve traction; however, any statements provided regarding improved traction or other features which may provide improved safety are not intended to guarantee, warrant or represent the safety of the scaffolding plank disclosed herein.

The larger perforations 20 and smaller raised areas with openings 22 form an exemplary perforation pattern “P,” having continually rows of larger perforations 20 extending the length of the deck 12 and offset along the width of the deck 12. Smaller perforations 22 occur in rows of five (5) alternating between larger perforations 20 in a given row across the width of plank 10. It is understood that a variety of alternative perforation patterns exist which can be provided in a variety of known ways. Alternative patterns are contemplated and considered within the scope of the present disclosure. In further embodiments, perforations may have multiple sizes between the larger perforations 20 and smaller perforations 22.

The plank 10 and the hooks 18 can be constructed of steel, although other materials are contemplated and considered within the scope of the present disclosure. In accordance with embodiments of the present disclosure, the scaffold plank 10 comprises a single perforated steel sheet metal roll formed section and a plurality, namely, four (4) steel hooks 18. These five (5) components or pieces are welded or otherwise secured together to form the scaffold plank 10 or steel scaffold plank. The plank 10 attaches to the scaffold (not shown) by means of the hooks 18 which rest on the horizontal members of the scaffold. The perforated portion of the plank may provide a flat horizontal surface to support a worker.

Accordingly, provided herein is a plank 10, such as a scaffold plank, which incorporates large perforations in a top (walking) surface of the plank. A bottom edge of the side rails are rolled or otherwise closed to retain strength and capacity of traditional scaffold planks, as well as to promote passage of media (e.g., blast media) or other debris or material without settling on the plank.

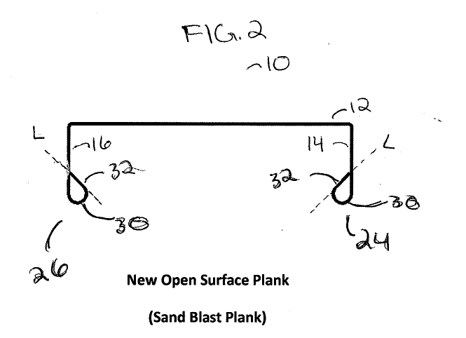

FIG. 2, which is a cross-sectional view of an exemplary scaffold plank 10 in accordance with embodiments of the present disclosure, shows sides 14, 16 with flanges 24, 26 which are closed, or roll closed, to prevent the accumulation of debris underneath deck 12. Flanges 24, 26 comprise rolled bottom surfaces 30 which are shown as rounded in FIG. 2, with angled closed surfaces 32 physically contacting the inner surface of sides 14, 16 and approaching sides 14, 16 at an approximate 44° to 46° angle, and preferably at a 45° angle. In the exemplary embodiment shown, rolled bottom surfaces 30 have an inner diameter of approximately 0.5 inches, and angled closed surfaces 32 physically contact sides 14, 16 at approximately 0.98 inches up from the bottom-most point of rolled bottom surfaces 30.

As shown in FIG. 2, closed surfaces 32 physically contact sides 14, 16 and approach sides 14, 16 at an angle of from about 44° to 46°. While closed surfaces 32 may not physically contact sides 14, 16 at an angle from about 44° to 46°, line “L” extends from closed surfaces 32 to intersect sides 14, 16 at an angle of from 44° to 46°, and preferably at 45°. In further embodiments, closed surfaces 32 physically contact sides 14, 16 at an angle of from about 44° to 46°, and preferably at an angle of about 45°. It is understood that the angle at which closed surfaces 32 approach or contact sides 14, 16 may permissibly vary.

It was discovered closed surfaces 32 approaching sides 14, 16 at the critical 45° angle to physically contact sides 14, 16 provide sufficient debris flow-off while minimizing the amount of material necessary to produce plank 10 and retaining the structural integrity of the plank 10. If closed surfaces 32 approach sides 14, 16 at a flatter angle, debris flow is hindered. If closed surfaces 32 approach sides 14, 16 at a steeper angle, additional material is required for closed surfaces 32 to reach and physically contact sides 14, 16.

Accordingly, a scaffold plank 10 is provided which incorporates large perforations 20 in a horizontal walking surface 12 of the steel scaffold plank 10, yet retains the strength of the industry standard steel plank by use of a closed, rolled portion (flanges 24, 26) of the side rail. The scaffold plank 10 is provided which allows an associated scaffold to be loaded to the same (or substantially the same) capacity as with traditional steel scaffold planks. In accordance with at least some embodiments, scaffold plank 10 is provided which incorporates large perforations 20 in combination with closed rolled side rail sections (flanges 24, 26), reducing accumulation of debris.

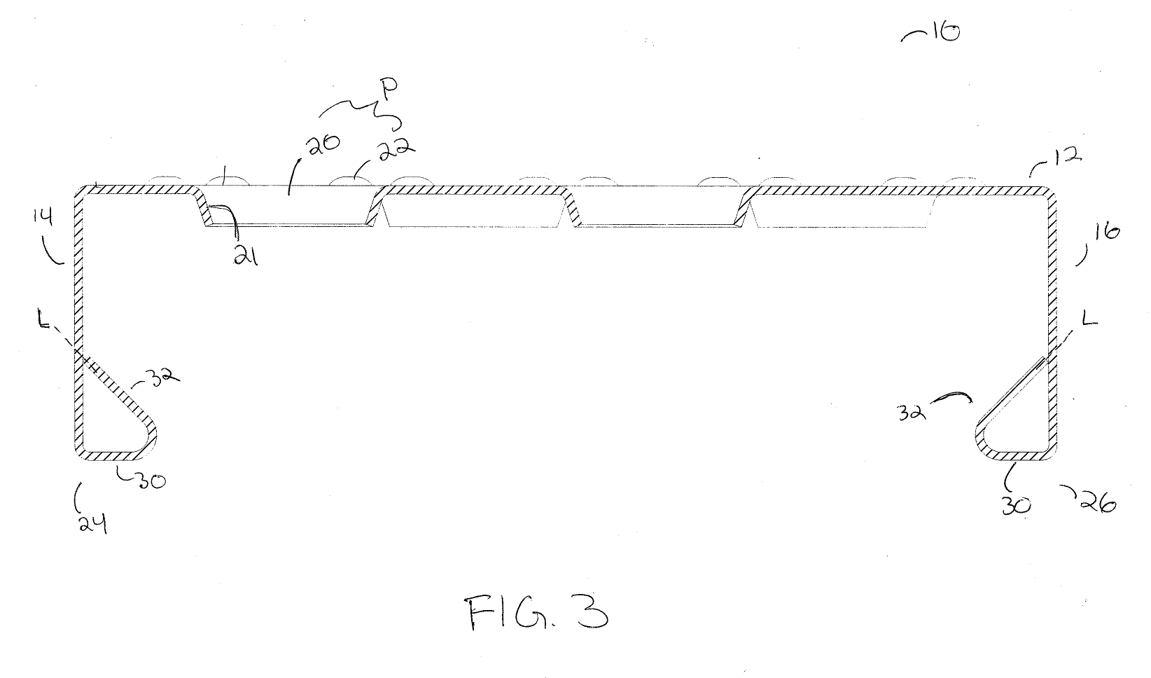

FIG. 3 is a cross-sectional view of the scaffold plank 10 of FIG. 1. As shown in FIG. 3, sides 14, 16 comprise formed flanges 24, 26 with rolled bottom surfaces 30 and closed surfaces 32. In the exemplary embodiment shown in FIG. 3, rolled bottom surfaces 30 are flattened and form an approximate 90° angle with sides 14, 16 to extend under and are substantially parallel to deck 12. Flattened rolled bottom surfaces 30 are thought to provide additional structural integrity to plank 10.

FIG. 3 more clearly shows perforation pattern “P,” with larger perforations 20 being offset across the width of plank 10 and smaller perforations 22 alternating in sets of five (5) between the rows of larger perforations 20. The larger perforations 20 and smaller raised areas with openings 22 form an exemplary perforation pattern “P,” having continually rows of larger perforations 20 extending the length of the deck 12 and offset along the width of the deck 12. In the exemplary embodiment shown, for each given row extending the width of plank 10, there are two (2) larger perforations 20 with five (5) smaller perforations, creating a two (2) row pattern “P” with a total of four (4) larger perforations and ten (10) smaller perforations in each repeating unit of perforation pattern “P.”

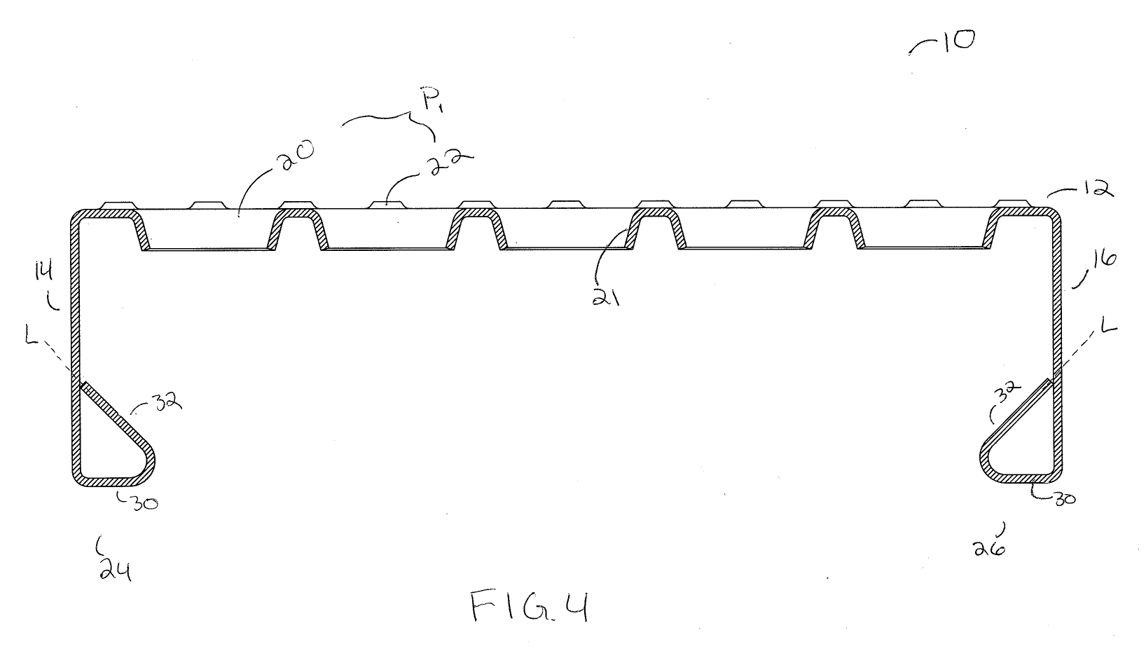

FIG. 4 is a cross-sectional view of a scaffold plank 10 in accordance with at least some embodiments of the present disclosure illustrating an alternative exemplary perforation pattern “P₁.” Perforation pattern “P₁” includes a plurality of larger perforations 20 extending in rows along the length of deck 12 and evenly spaced in rows along the width of deck 12. Smaller perforations 22 alternate between larger perforations 20 in rows across both the length and width of deck 12.

In the embodiments shown in FIGS. 2 and 3, closed surfaces 32 physically contact sides 14, 16 and approach sides 14, 16 at an angle of from about 44° to 46°. While closed surfaces 32 may not physically contact sides 14, 16 at an angle from about 44° to 46°, line “L” extends from closed surfaces 32 to intersect sides 14, 16 at an angle of from 44° to 46°, and preferably at 45°. In further embodiments, closed surfaces 32 physically contact sides 14, 16 at an angle of from about 44° to 46°, and preferably at an angle of about 45°. It is understood that the angle at which closed surfaces 32 approach or contact sides 14, 16 may permissibly vary.

As shown in both FIG. 3 and FIG. 4, larger perforations 20 are circular and have an inwardly angled inner surface 21 acting as a funnel to further direct debris downward and away from deck 12. It is understood that larger perforations 20 may have any design or shape known in the art to provide an opening through which debris may pass. Smaller perforations 22 may also be circular and include an inwardly angled inner surface. However, it is to be understood that both large and small perforations 20, 22 may have any shape or dimension known in the art to facilitate the removal and/or prevent the build-up of debris on deck 12. For example, larger and/or smaller perforations 20, 22 may be circular, square, rectangular, slots, triangular and combinations thereof. In some embodiments, deck 12 may include perforations of more than two sizes or shapes. In still further embodiments, deck 12 may include perforations of a single size and shape.

Both FIG. 3 and FIG. 4 also show that smaller perforations 22 are raised above deck 12 in addition to providing openings through which debris may flow. However, in some embodiments, smaller perforations 22 may be raised but not contain openings.

Accordingly, a plank 10, such as a scaffold plank, is provided herein which integrates openings or perforations 20, 22 in the walking surface 12 to be configured for reduced accumulation of debris and other materials, and with a pair closed rolled side rail sections (flanges 24, 26) configured to allow for the passage of debris and other materials without loss (or of load carrying capacity as compared to prior solutions).

FIG. 3 and FIG. 4 also show plank 10 as made from a single piece of material which is formed, and in some embodiments preferably roll formed, to create flanges 24, 26. Plank 10 is therefore a single integral structure with the exception of hooks 18 (not shown), which may be manufactured separate from plank 10 and later permanently or selectively attached to plank 10.

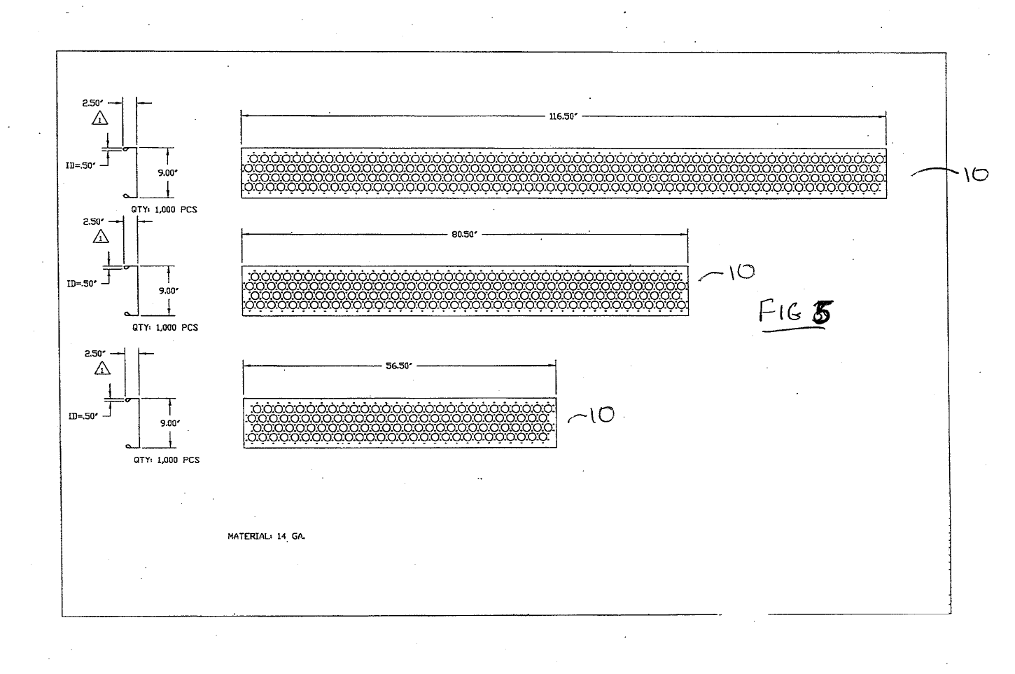

FIG. 5 illustrates top and cross-sectional views of exemplary embodiments of a scaffold plank 10 in accordance with embodiments of the present disclosure. As understood from the exemplary embodiments shown in FIG. 5, scaffold plank 10 may have varying dimensions and lengths. For example, the width of planks 10 is shown in FIG. 5 to be approximately 9.0 inches, while the lengths vary at 56.50 inches, 80.50 inches and 1116.50 inches. The length of sides 14, 16 is approximately 2.50 inches, and the sides 14, 16 are roll formed at a radius of approximately 0.06 inches to extend away from deck 12 at a final 90° angle. Deck 12 is approximately 0.0747 inches thick.

In accordance with embodiments of the present disclosure, the walking surface (deck 12) of the plank 10 is made from 14 gauge steel coil which is fed through a single continuous roll forming line comprised of several stations (not shown). At a first station, a die device stamps the larger and smaller perforations 20, 22. In some embodiments, the die device includes a single repetitive unit of a perforation pattern “P,” while in other exemplary embodiments the die device includes multiple repeating units of perforation patter “P” corresponding to a desired length of deck 12 or plank 10. As the steel coil continues through the first station, the die device may stamp the steel coil such that a continuous perforation pattern “P” is created for the length of the steel coil with no space between stampings. In other embodiments, an unstamped distance of variable length is provided between stamped perforation patterns “P.” In still other embodiments, the die device may stamp a given length of steel coil, requirement multiple stamps, with an unstamped distance provided between lengths of stamped steel coil.

The coil continues on to the roll forming portion of the line in which a series of steel rollers (or other devices) forms the coil into the desired shape, such as is illustrated herein, for example, as in FIGS. 1-5. As the steel coil passes through the rollers, the sides 14, 16 are incrementally roll formed at a 0.6 inch radius to extend away from deck 12 at an ultimate 90° angle. Flanges 24, 26 are then incrementally roll formed back upward from sides 14, 16 until closed surface 32 physically contacts sides 14, 16.

In some embodiments, when the steel coil will be ultimately cut into multiple planks, a second die device may be provided to stamp out portions of steel inward from the sides of the steel coil but not extending the entire width of the coil prior to the roll forming. The cuts, when present, are typically equal to the total length of the sides 14, 16 and flanges 24, 26, and thereby make the roll forming process easier. These cuts or perforations may occur at locations along the steel coil free from stamped perforation pattern “P.”

Located at a final station is a traveling cut-off die which cuts the finished section to a desired size (length). Various exemplary lengths are illustrated in FIG. 5, as described above. Representative sizing is illustrated in the FIGS. 1 to 5 and such sizing should not be considered as limiting. When a second die device is provided to cut the steel coil at discrete lengths prior to roll forming, as discussed above, the traveling cut-off die cuts the coil at the location of the prior cuts.

In accordance with embodiments of the present disclosure, the plurality, as shown four (4) steel hooks 18 are stamped from ½ plain carbon steel. Other materials are contemplated for the scaffold plank and hooks and considered within the scope of the present disclosure. The materials identified are provided to facilitate manufacture and should not be considered as limiting. The plurality, as shown four (4) hooks and length of roll formed sections (deck) are, if welded together, typically placed in a weld fixture to secure them in the desired configuration, and then subsequently welded together. Other methods of securing the hooks to the deck are contemplated and considered within the scope of the present disclosure.

Scaffold plank 10 (which in at least some embodiments can take the form of a completed weldment) can be hot dipped galvanized, or otherwise treated, for corrosion protection. Other ways to protect the plank from corrosion or deterioration are contemplated and considered within the scope of the present disclosure.

In further embodiments, particularly when scaffolding plank 10 is aluminum, plank 10 may be extruded. Any method of making or constructing a plank or scaffold plank, or any portion, aspect, feature, step or action of or associated with the method is provided as well to facilitate understanding and should not be considered in a limiting sense.

In accordance with embodiments of the present disclosure, a scaffold plank is provided which can be used in any (or at least almost any) industry that requires scaffold plank to retain industry standard capacity, and installation heights in comparison with traditional steel scaffold planks, while at the same time reducing the accumulation of debris on the surface of the plank. Typical uses or applications that are contemplated include: power plant boilers (e.g., during outages, when cleaning the dirt and debris from the heat transfer tubes) and, in shipyards, when removing paint and corrosion from the hull of a ship (e.g., in preparation for re-application of corrosion protecting paints and coatings). Accordingly, application of a scaffold plank of the kind described herein can be varied and include portions of the personnel access market related to, for example, the cleaning of power plant boilers, as well as the removal of paint, and corrosion by sand/media blasting.

Various alternatives are contemplated and considered within the scope of the present disclosure. Plank structures of the kind disclosed herein can have many variations, including as already noted. In addition, it should be understood that the overall shape of the plank structures can vary to some degree while maintaining overall functionality.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

We claim:

1. A scaffold plank structure comprising:
a deck portion having a plurality of perforations;
two formed side portions, each of said side portions including a formed flange with a bottom surface and a closed surface, wherein said closed surfaces physically contact said side portions and approach said side portions such that a line extending from said closed surfaces intersects said side portions at an angle of from about 44° to about 46° relative to said side portions; and
a plurality of hook structures attached to said deck portion and configured to receive and be supported by a scaffold system,
wherein said deck portion, side portions and flanges are integrally formed.

2. The scaffold plank structure of claim 1 wherein said bottom surfaces are rounded.

3. The scaffold plank structure of claim 2 wherein said rounded bottom surfaces have an inner diameter of 0.5 inches.

4. The scaffold plank structure of claim 1 wherein said bottom surfaces are flattened and substantially parallel with said deck.

5. The scaffold plank structure of claim 1 wherein said closed surfaces approach said side portions such that a line extending from said closed surfaces intersects said side portions at an angle of about 45°.

6. The scaffold plank structure of claim 1 wherein said closed surfaces physically contact said side portions at an angle of about 44° to about 46°.

7. The scaffold plank structure of claim 1 wherein said closed surfaces physically contact said side portions at an angle of about 45°.

8. The scaffold plank structure of claim 1 wherein said perforations are selected from the group consisting of larger perforations, smaller perforations and combinations thereof.

9. The scaffold plank structure of claim 1 wherein said plurality of perforations includes perforations different in at least one of size and shape.

10. The scaffold plank structure of claim 1 wherein at least a portion of said plurality of perforations has an inner surface having an inward angle.

11. The scaffold plank structure of claim 1 wherein at least a portion of said plurality of perforations is raised above said deck.

12. The scaffold plank structure of claim 1 wherein said flanges are roll formed.

13. The scaffold plank structure of claim 1 wherein said flanges have an inner width of .50 inches at the widest point.

14. The scaffold plank structure of claim 1 wherein said deck is .0747 inches thick.

15. The scaffold plank structure of claim 1 made from 14 gauge steel.

16. A method of making a plank structure comprising the steps of:
stamping a portion of a steel coil with a die device thereby forming a perforation pattern, wherein said steel coil has two side edges;
forming said side edges of said stamped steel coil to form two side portions;
forming said side portions to form two flanges, said flanges containing a bottom surface and a closed surface;
forming said closed surfaces such that said closed surfaces are in physical contact with said side portions at an angle of from 44° to 46°; and
cutting said formed steel coil into a desired length to form said plank structure.

17. The method of claim 16 wherein said forming is roll forming.

18. The method of claim 16 which further includes cutting said steel coil at an inward direction from said side edges, wherein the length of each cut is equal to the total length of one of said side portions and one of said flanges prior to said forming and cutting.

19. The method of claim 16 which further includes treating said plank structure to prevent corrosion.

20. The method of claim 16 which further includes welding a plurality of hooks to said plank structure.
